(19) United States
(12) Patent Application Publication
(10) Pub. No.: US 2006/0132105 A1
(43) Pub. Date: Jun. 22, 2006

(54) Controlling inrush current

(76) Inventors: Atluri R. Prasad, Houston, TX (US); Hai N. Nguyen, Spring, TX (US)

Correspondence Address: HEWLETT-PACKARD COMPANY;Intellectual Property Administration, P.O. Box 272400, Fort Collins, CO, 80527-2400, US

(21) Appl. No.: 11/012,242

(22) Filed: Dec. 16, 2004

(51) Int. Cl. G05F 1/656; G05F 1/10

(52) U.S. Cl. 323/222

(57) ABSTRACT

A control circuit and method for controlling a power factor correction circuit comprising: an inductor having an input terminal to receive an input voltage and an output terminal series connected to an anode of a diode; a first capacitor connected between a cathode of said diode and ground; a first switch connected between an anode of said diode and ground; a series arrangement of a second capacitor and a parallel arrangement of a resistor and a second switch series connected with said second capacitor. The control circuit is operable to generate synchronous first and second switch control signals to respectively control said first and second switches, wherein during inrush current conditions when said input voltage drops-in after an interruption, said control circuit is operable to cause said first and second switches to be synchronously switched at increasing duty cycles. The method comprises charging a first capacitor from an input voltage source; isolating the first capacitor from the input voltage source; transferring a portion of charge stored in said first capacitor to a second capacitor while said input voltage source is isolated from said first capacitor and from said second capacitor; and repeatedly said charging, isolating, and transferring until a voltage is formed on said second capacitor that is approximately equal to said input voltage source.

### BACKGROUND

1. Field of the Invention

The present invention relates generally to inrush current and, more particularly, to controlling inrush current.

2. Related Art

Line-operated power supplies that are used to supply power to computers, servers and other systems normally receive power from single-phase alternating current (AC) utility voltage (110 V RMS in the United States and 220 V RMS in Europe and Asia). Typical power supplies have at their front-end a power factor correction (PFC) circuit to insure the input power factor is near unity. Unity power factor requires the instantaneous input current to be proportional to the instantaneous input voltage. When this relationship is attained, the PFC circuit appears as a resistive load to the AC power source, while generating a regulated DC voltage for load line variations from, for example, 90VAC RMS to 264VAC RMS.

When a power supply is connected to the AC power source, a short-duration, high-amplitude, input current, commonly referred to as an inrush current, results as a capacitor internal to the power supply stored energy. The inrush current may be significantly greater than the steady state current until the power supply reaches equilibrium; that is, the transient effect continues until the voltage across the internal power supply capacitor reaches a voltage approximately equal to the peak amplitude of the AC line voltage. If left uncontrolled, a high inrush current can damage components, trip circuit breakers, and have other undesirable effects.

### SUMMARY

Embodiments of the present invention are directed to a method for controlling inrush current in a power supply, comprising: charging a first capacitor from an input voltage source; isolating the first capacitor from the input voltage source; transferring a portion of charge stored in said first capacitor to a second capacitor while said input voltage source is isolated from said first capacitor and from said second capacitor; and repeatedly said charging, isolating, and transferring until a voltage is formed on said second capacitor that is approximately equal to said input voltage source.

### BRIEF DESCRIPTION OF THE DRAWINGS

FIG. 1 is a simplified schematic diagram of one embodiment of a power supply circuit of the present invention.

FIG. 2A is a waveform of an AC line voltage provided to the power supply circuit illustrated in FIG. 1 during system start-up, in accordance with one embodiment of the present invention.

FIG. 2B is a waveform of the voltage across the current limiting capacitor in the power supply circuit illustrated in FIG. 1 during system start-up, in accordance with one embodiment of the present invention.

FIG. 2C is a waveform of the voltage across the output capacitor in the power supply circuit illustrated in FIG. 1 during system start-up, in accordance with one embodiment of the present invention.

FIG. 2D is a waveform of the input current provided to the power factor correction circuit illustrated in FIG. 1 during system start-up, in accordance with one embodiment of the present invention.

FIG. 2E is a waveform of the power factor circuit control signal generated by the boost converter control circuit to control the gate of the boost switch transistor in the power supply circuit illustrated in FIG. 1 during system start-up, in accordance with one embodiment of the present invention.

FIG. 2F is a waveform of the input current control signal generated by the inrush current control circuit to control the gate of the current limiting switch transistor in the power supply circuit illustrated in FIG. 1 during system start-up, in accordance with one embodiment of the present invention.

FIG. 3A is a waveform of the AC line voltage provided to the power supply circuit illustrated in FIG. 1 prior to, during, and subsequent to an interruption in the AC line voltage, in accordance with one embodiment of the present invention.

FIG. 3B is a waveform of the soft-start voltage in the power supply circuit illustrated in FIG. 1 prior to, during, and subsequent to an interruption in the AC line voltage, in accordance with one embodiment of the present invention.

FIG. 3C is a waveform of the power factor correction control signal which drives the gate of the boost switch transistor in the power supply circuit illustrated in FIG. 1 prior to, during, and subsequent to an interruption in the AC line voltage, in accordance with one embodiment of the present invention.

FIG. 3D is a waveform of the inrush current control signal which drives the gate of the current limiting switch transistor in the power supply circuit illustrated in FIG. 1 prior to, during, and subsequent to an interruption in the AC line voltage, in accordance with one embodiment of the present invention.

FIG. 3E is a waveform of the output voltage across the output capacitor of the power factor correction circuit illustrated in FIG. 1 prior to, during, and subsequent to an interruption in the AC line voltage, in accordance with one embodiment of the present invention.

FIG. 3F is a waveform of the input current provided to the power factor correction circuit illustrated in FIG. 1 prior to, during, and subsequent to an interruption in the AC line voltage, in accordance with one embodiment of the present invention.

FIG. 4 is a simplified schematic diagram of one embodiment of the inrush current control circuit illustrated in FIG. 1.

FIG. 5 is a simplified schematic diagram of an alternative embodiment of a power supply circuit of the present invention.

FIG. 6 is a simplified schematic diagram of an alternative embodiment of a power supply circuit of the present invention.

FIG. 7 is a block diagram of an exemplary device in which an embodiment of the present invention is implemented.

### DETAILED DESCRIPTION

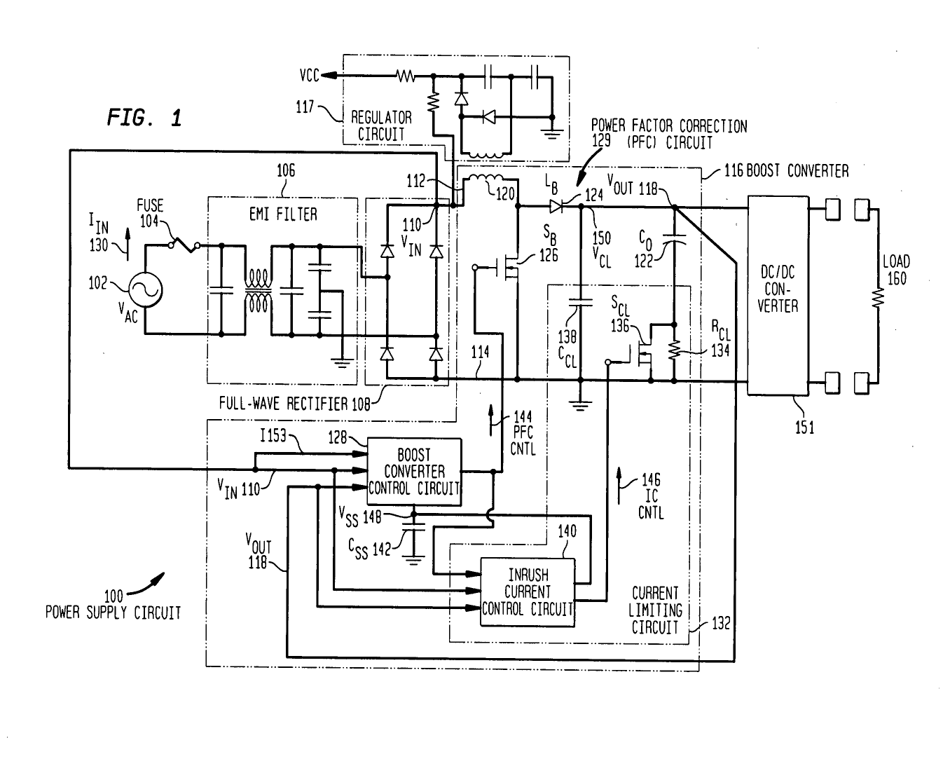

FIG. 1 is simplified schematic diagram of a power supply circuit 100 in accordance with one embodiment of the present invention. An alternating current (AC) voltage V_{AC} 102 such as a utility line voltage is received through a fuse 104. AC line voltage 102 is filtered through an electromagnetic interference (EMI) filter 106 and provided to a full-wave rectifier 108. Full-wave rectifier 108 rectifies AC line voltage 102 to provide a rectified input voltage V_{IN} 110 on conductor 112 with respect to a reference or ground conductor 114. In the exemplary embodiment shown in FIG. 1, rectifier 108 is a diode rectifier, although in alternative embodiments other types of rectifiers may be used. EMI filter 106 and rectifier 108 are collectively referred to herein as a phase control rectifying circuit. The structure and operation of EMI filter 106 and rectifier 108 are well-known to those of ordinary skill in the art and, therefore, are not described further herein.

Power supply circuit 100 also comprises a boost converter circuit 116 series connected to EMI filter 106 and rectifier 108 to provide an output voltage V_{OUT} 118 for a load 160. In FIG. 1, load 160 is generically represented by a resistor, as is customary in the art. Power supply circuit 100 also comprises a regulator circuit 117 which steps down the voltage to a voltage level, such as 12 volts, suitable for use by the components of power supply circuit 100. It should be appreciated that the components of regulator circuit 117 illustrated in FIG. 1 are exemplary only, and that any regulator circuit now or later developed may be utilized. Regulator circuit 117 is well-known in the art and, therefore, is not described in further detail. Similarly, power supply circuit 100 also comprises a DC/DC converter circuit 151 for converting output voltage 118 to a voltage suitable for use by the components of the implementing system. DC/DC converter circuit 151 is well-known in the art and, therefore, is not described in further detail.

Boost converter circuit 116 comprises a number of components collectively referred to as a power factor correction (PFC) circuit 129, and a control circuit 128 that controls the operation of PFC circuit 129 as described herein. As noted, power supplies commonly include a PFC circuit to insure the input power factor is near unity. This enables PFC circuit 129 to appear as a resistive load to the AC power source which provides AC line voltage 102, while providing a regulated DC voltage 118 to load 160. In addition, boost converter 116 includes a current limiting circuit 132 that further controls the operation of boost converter 116 to limit inrush current during start-up and AC line interruptions. The structure and operation of embodiments of current limiting circuit 132 are described in detail below.

PFC circuit 129 comprises a boost inductor L_{B} 120 having an input terminal connected to an output terminal of full-wave rectifier 108. A p-n diode 124 is series connected between the output terminal of boost inductor 120 and output capacitor 122, serving as a one-way valve for current flow. A boost switch S_{B} 126, implemented as a MOSFET in FIG. 1, is connected between the output terminal of inductor 120 and ground conductor 114. It should be appreciated that in alternative embodiments boost switch 126 may be implemented as an electronic switch other than a MOSFET. An output capacitor C_{O} 122 (also referred to as a bulk capacitor or a hold-up capacitor) is connected across the cathode of diode 124 and ground conductor 114 in series with a current limiting resistor 134 or current limiting switch 136, as described below. Output voltage 118 is provided across the terminals of output capacitor 122 in series with current limiting resistor 134 or MOSFET 136.

Boost switch 126 is controlled by boost converter control circuit 128 which generates a PFC control signal 144 to drive the gate of the boost switch MOSFET. As shown in FIG. 1, boost converter control circuit 128 receives as inputs output voltage 118, input voltage 110 and rectified input current 153. The structure and operation of boost converter control circuit 128 is well-known in the art and not described in further detail herein. Control circuit 128 may be, for example, UCC3817 BiCMOS Power Factor Preregulator, commercially available from Texas Instruments Incorporated. As one or ordinary skill in the art would appreciate, other PFC control circuits now or later developed which are consistent with the teachings of the present invention may be used in alternative embodiments to control boost switch 126 of PFC circuit 129.

As noted, power supply circuit 100 also comprises an in-rush current limiting circuit 132, one embodiment of which is illustrated in FIG. 1. Inrush current limiting circuit 132 comprises, in the embodiment shown in FIG. 1, a current limiting resistor R_{CL} 134 connected in series between output capacitor 122 and ground conductor 114. Connected in parallel with resistor 134 is a current limiting switch S_{CL} 136. In FIG. 1, current limiting switch 136 is implemented as a MOSFET, although current limiting switch 136 may be implemented with other electronic switches in alternative embodiments. In-rush current limiting circuit 132 also comprises a current limiting capacitor C_{CL} 138 connected between an output terminal of diode 124 and ground conductor 114, and is in parallel with a series arrangement of output capacitor 122 and either MOSFET 136 or resistor 134.

Current limiting switch 136 is controlled by an inrush current control circuit 140. Inrush current control circuit 140 receives as inputs PFC control signal 144, input voltage 110 and output voltage 118. Based on these inputs, embodiments of inrush current control circuit 140 generate an inrush current control signal 146 to drive the gate of current limiting switch 136 to limit inrush current in boost converter 116 during AC line drop-in conditions. The structure and operation of embodiments of inrush current control circuit 140 are described in detail below.

As noted, when AC line voltage 102 is initially applied to power supply circuit 100 (i.e., during start-up) and when AC line voltage 102 drops-in (i.e., after a momentary interruption in the AC line voltage), output voltage 118 may temporarily be less than input voltage 110. When this occurs, power supply circuit 100 transitions to steady state operations in which output voltage 118 is maintained at some steady state value. During this transitional period, input current 130 may experience a transient yet potentially significant increase above its steady state value. As noted, input current 130 is commonly referred to as inrush current when subject to such transient effects. These and other conditions which may give rise to an inrush current are generally and collectively referred to herein as inrush current conditions.

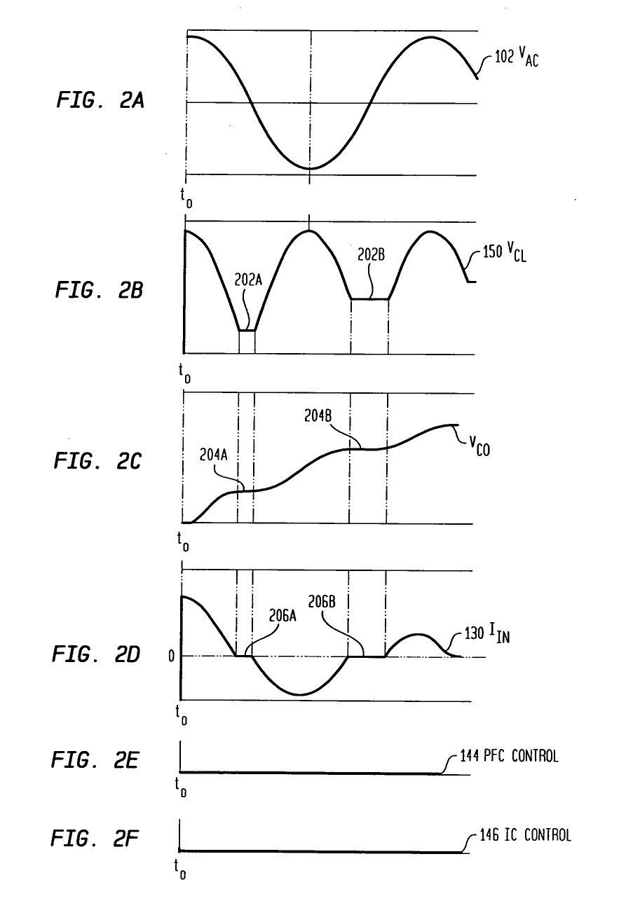

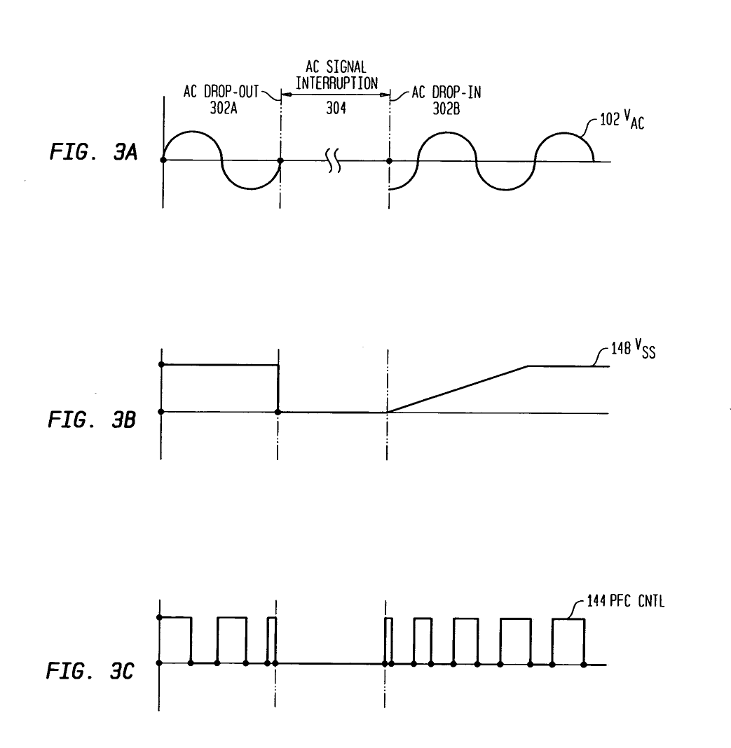

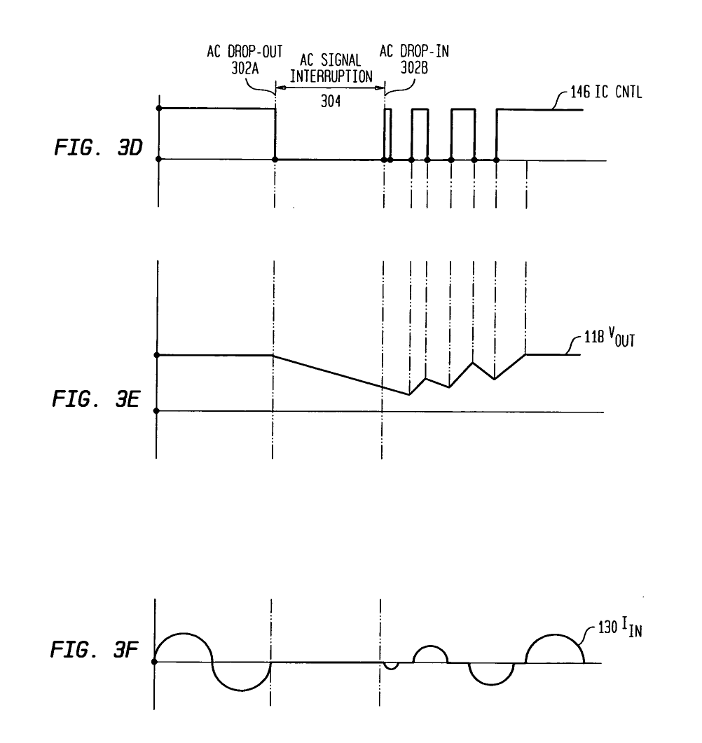

Embodiments of the present invention limit the amplitude and duration of inrush current during inrush current conditions; that is, during start-up and AC line interruptions. These two modes of operation are dictated by the different initial conditions of power supply circuit 100. For example, during start-up, there is no voltage (Vcc) currently being supplied to inrush current control circuit 140, and there is no charge stored in output capacitor 122. In contrast, during AC line voltage interruption, inrush current control circuit 140 is powered by Vcc. In the following description, the operation of embodiments of the present invention to limit inrush current during inrush current conditions occurring when AC line voltage is initially applied to power supply circuit 100 will first be described with reference to FIGS. 2A-2F. Then, operations of embodiments of the present invention to limit inrush current during inrush current conditions occurring when AC line voltage drops-in after a momentary interruption will be described with reference to FIGS. 3A-3F.

FIGS. 2A-2D include voltage and current waveforms taken at various locations in power supply circuit 100 illustrated in FIG. 1 during system start-up. FIG. 2A is a waveform of AC input line voltage 102. FIG. 2B is a waveform of the voltage V_{CL} 150 across current limiting capacitor 150. FIG. 2C is a waveform of the voltage across output capacitor 122. FIG. 2D is a waveform of input current 130. In addition, FIG. 2E is a waveform of PFC control signal 144 which controls the gate of boost switch 126. FIG. 2F is a waveform of inrush current control signal 146 which controls the gate of current limiting switch 136.

At start-up, boost converter control circuit 128 and inrush control circuit 140 are initially not powered because their input voltage Vcc is derived either from DC output voltage 118 or from boost inductor as shown in FIG. 1 (117 or Vcc). As a result, control voltages 144 and 146 are unavailable to drive boost switch 126 and current limiting switch 136. As a result, the two switches 126, 136 are initially open at time to, as shown in FIGS. 2E and 2F.

Referring to the waveform of AC line voltage 102 shown in FIG. 2A, AC line voltage 102 is connected to power supply circuit 100 at time t₀. As one of ordinary skill in the art would appreciate, the greatest inrush current 130 may occur when there is the greatest difference between AC line voltage 102 and output voltage 118. The following description will be provided in the context of such a circumstance, for example, when AC line voltage 102 is at 264VAC RMS, which is at the peak of the AC line voltage, as shown in FIG. 2A.

Because boost switch 126 is open, current starts flowing through boost inductor 120 and output capacitor 138 and capacitor 122. Referring to the waveform of voltage V_{CL} 150 across current limiting capacitor 150 shown in FIG. 2B, current limiting capacitor 138 is quickly charged to a peak value at system start-up (time t₀). In the above example in which AC line voltage 102 is 264VAC RMS, voltage 150 attains an initial value of approximately 373 volts.

The voltage difference between input voltage 110 and output voltage 118 is applied across boost inductor 120, causing capacitor 138 to store energy. It should be appreciated that, as noted, capacitor 138 and capacitor 122 are selected such that capacitor 138 charges quickly, taking much less time than capacitor 122 to charge. In one embodiment, the capacitance of capacitor 122 is 100-500 times the capacitance of capacitor 138. In one particular embodiment, for example, the value of capacitor 138 is approximately less than 10 microfarads and the value of capacitor 122 is approximately greater than 390 microfarads. In this latter embodiment, for example, the current flowing through capacitor 138 during start-up is less than 5 amperes and charges capacitor 138 in less than 100 microseconds.

Referring to the current waveform shown in FIG. 2D, inrush current 130 initially rises due to the charging of current limiting capacitor 138. However, because current limiting switch 136 is also open at this time, current limiting resistor 134 is in series with output capacitor 122. As a result, inrush current 130 flowing through output capacitor 122 is limited by resistor 134. This prevents capacitor 122 from charging to the peak value of the AC input voltage, thereby maintaining the voltage across the output capacitor 122 at a much lower value.

During the first quarter-cycle of AC line voltage 102, the line voltage decreases, as shown in FIG. 2A. As this occurs, capacitor 138 discharges, transferring energy to capacitor 122. This is illustrated in FIG. 2B with a decrease in voltage 150 across current limiting capacitor 138. This is also illustrated in FIG. 2C with an increase of the voltage across output capacitor 122.

Concurrent with the charging of capacitor 138, line voltage 102 decreases. At some point in time, line voltage 102 drops below voltage 150 across capacitor 138, causing the cessation of energy transfer from inductor 120 to current limiting capacitor 138. This is illustrated by a plateau 202A in the current limiting voltage 150 waveform shown in FIG. 2B. This is also illustrated in FIG. 2C by the corresponding plateau 204A in the voltage waveform of output capacitor 122.

When this occurs, the voltage across inductor 120 is reversed, and diode 124 becomes reverse biased. This enables inductor 120 to gradually reset its flux, preventing the inductor from saturating. Also, this causes inrush current 130 to stop flowing. This is illustrated by the corresponding plateau 206A in the waveform of inrush current 130 shown in FIG. 2D. This will continue until capacitor 138 sufficiently discharges into capacitor 122 and the rectified input AC voltage rises and forward biases diode 124.

During the second quarter-cycle of input line voltage 102 depicted in FIG. 2A, the line voltage continues to sinusoidally decrease. Input voltage 110 applied to inductor 120 increases due to full-wave rectifier 108. The voltage across capacitor 138, shown in FIG. 2B, remains constant until input line voltage 102 surpasses capacitor voltage 150, at which time capacitor voltage 150 follows rectified input voltage 110.

During this second-quarter cycle of input line voltage 102, capacitor 138 continues to discharge into capacitor 122, as illustrated in the upward ramp in the waveform of output capacitor voltage shown in FIG. 2C. Inrush current 130 decreases as voltage 150 across capacitor 138 increases, as shown in FIG. 2D.

During the next quarter-cycle of AC line voltage 102 (the third-quarter cycle in the waveform depicted in FIG. 2A), the line voltage begins to sinusoidally increase. Input voltage 110 which, as noted, is the rectified version of line voltage 102, decreases. At some point in time, input voltage 110 drops below voltage 150 across capacitor 138, causing the cessation of energy transfer from current limiting capacitor 138 and output capacitor 122. This is illustrated by a plateau 202B in the waveform of current limiting voltage 150 shown in FIG. 2B. It should be appreciated that due to the accumulation of energy in current limiting capacitor 138, plateau 202B occurs at a greater voltage level than prior plateau 202A, as shown in FIG. 2B. This is also illustrated in FIG. 2C by the corresponding plateau 204B in the waveform of the output capacitor voltage 122. When this occurs, the voltage across inductor 120 is reversed, and diode 124 is reverse biased. This, as noted, causes inrush current 130 to stop flowing, as illustrated by the plateau 206B in the waveform of inrush current 130 shown in FIG. 2D.

Similar operations occur during subsequent cycles of AC input line voltage 102. Eventually, and within a very few cycles of AC input line voltage 102, current limiting capacitor 138 and output capacitor 122 will be fully charged at the peak AC input voltage. During each successive cycle of AC line voltage 102, inrush current 130 decreases from a maximum value to zero, as shown in FIG. 2D. The maximum inrush current 130 is determined by the ratio of the maximum input voltage 264VAC RMS (peak voltage of 373 volts) divided by the resistance of current limiting resistor 134. In this example, the maximum value of input voltage is 373 volts and resistor 134 may be, for example, 10 ohms, resulting in a maximum inrush current 130 of 37.3 amperes.

As shown in FIG. 2E, PFC control signal 144 is not asserted throughout the time the inrush current condition exists during start-up. When inrush current 130 reaches zero, marking the end of the inrush current condition, boost switch 126 is periodically turned on and off to continually transfer power from inductor 120 to bulk capacitor 122. This is described in further detail below.

As shown in FIG. 2F, IC control signal 146 is not asserted throughout the time the inrush current condition exists during start-up. This is to retain resistor 134 in series with output capacitor 122 as energy is accumulated in output capacitor 122. When output voltage 118 reaches 370 volts, current limiting switch 136 is turned-on continuously to operationally remove current limiting resistor 134 from boost converter 116.

FIGS. 3A-3F are exemplary waveforms illustrating the operation of power supply circuit 100 prior to, during and after an interruption in AC line voltage 102, in accordance with one embodiment of the present invention. FIG. 3A is a waveform of AC line voltage 102. FIG. 3B is a waveform of soft-start voltage V_{SS} 148. FIG. 3C is a waveform of PFC control signal 144 which, as noted, drives the gate of boost switch 126. FIG. 3D is a waveform of IC control signal 146 which, as noted, drives the gate of current limiting switch 136. FIG. 3E is a waveform of output voltage 118 across capacitor 122. FIG. 3F is a waveform of input current 130.

In each of these waveforms, there are two vertical lines 302A and 302B. Vertical line 302A represents the moment in time at which AC line voltage 102 drops-out, while vertical line 302B represents the moment in time at which AC line voltage returns, or drops-in. The time interval 304 between these two events, that is, the time interval during which AC line voltage 102 is interrupted, is typically less than 20 milliseconds. To the left or prior to AC drop-out event 302A, power supply circuit 100 is operating in a normal, steady state condition. To the right, or subsequent to the AC drop-in event 302B, power supply circuit 100 transitions to steady state operations in a manner which limits in-rush current, as described herein.

During steady-state conditions, line voltage 102 is a continuous sinusoidal voltage signal, as shown in FIG. 3A, and power supply 100 generates a relatively constant output voltage 118, as shown in FIG. 3E. Under such steady state conditions, there is no inrush current and input current 130 is proportional to input line voltage 102, as shown in FIG. 3F. Soft-start capacitor 142 is fully charged during steady state conditions, as shown by the constant value of soft-start voltage 148 in FIG. 3B. When output voltage 118 is at its steady state value, inrush current control circuit 140 holds inrush current control signal 146 high, as shown in FIG. 3D. This maintains MOSFET 136 in its closed state, eliminating the power dissipation effects of resistor 134 during steady state operating conditions. Boost converter control circuit 128 generates a pulse width modulated PFC control signal 144 as shown in FIG. 3C. Under steady-state operating conditions, the duty cycle of PFC control signal 144 is based on the values of input voltage 110 and output voltage 118. The periodic switching of boost switch 126 causes the periodic transfer of current from inductor 120 to output capacitor 122.

The above steady-state operations continue until there is an interruption 304 in AC line voltage 102. During AC signal interruption 304, load 160 is supported by output capacitor 122 through the anti-parallel diode of current limiting switch 136. That is, output capacitor 122 starts discharging into load 160. At the end of interruption period 304, output voltage 118 across output capacitor 122 will be lower, for example, at approximately 300 volts. This is illustrated in the output voltage 118 waveform illustrated in FIG. 3E. As shown therein, output voltage 118 is constant prior to AC drop-out event 302A, and ramps downward during interruption period 304.

When inrush current control circuit 140 detects the cessation of input voltage 110, it sets soft-start voltage 148 to ground potential, causing soft-start capacitor 142 to discharge. This is illustrated in FIG. 3B. This causes boost converter control circuit 128 to cease generating PFC control signal 144, as illustrated in FIG. 3C. Similarly, inrush current control circuit 140 ceases generating IC control signal 146, as illustrated in FIG. 3D. Thus, at the instant of AC drop-in 302B both switches 126 and 136 are open.

At AC line drop-in 302B, line voltage 102 may be at any arbitrary value in its cycle. In the exemplary embodiments described below, AC drop-in 302B occurs at the peak of input voltage 110 waveform of, for example, 264VAC RMS. Such a circumstance conventionally resulted in the greatest difference between input and output voltages and, hence, the greatest inrush current. This is illustrated in FIG. 3A, wherein line voltage 102 is at its lowest value. As such, input voltage 110 generated by rectifier 108 is at its peak value.

At AC drop-in 302B, inrush current control circuit 140 releases soft-start capacitor 142, allowing the soft start-capacitor to begin accumulating stored energy. This, in turn, causes V_{SS} 148 to gradually increase, as shown in FIG. 3B.

At the instant of AC drop-in 302B both switches 126 and 136 are open, because PFC control signal 144 and inrush current control signal 146 are both low. However, because soft-start-capacitor 142 is being charged, PFC control circuit 128 may generate a PFC control signal 144 having a logic high or low value immediately subsequent to AC drop-in 302B. Because inrush current control signal 146 has the same instantaneous value as PFC control signal 144, it too will have either a logic high or low value immediately subsequent to AC drop-in 302B. In the example illustrated in FIGS. 3C and 3D, PFC control signal 144 and inrush current control signal 146 have a logic high value immediately subsequent to AC drop-in 302B. As a result, boost switch 126 and current limiting switch 136 are both closed in this illustrative example.

The continual increase of V_{SS} 148 after AC drop-in 302B causes boost converter control circuit 128 to gradually increase the duty cycle of the PFC control pulse waveform 144, as shown in FIG. 3C. Since V_{IN} 110 is below its steady-state value, inrush current control circuit 140 causes inrush current control signal 146 to have the same instantaneous value as PFC control signal 144, as shown in FIG. 3D. Thus, during inrush current conditions after an AC line interruption 304, boost switch 126 and current limiting switch 136 are synchronously switched at a slowly increasing duty cycle proportionate with the accumulation of energy in soft-start capacitor 142.

As switches 126 and 136 open and close, they control the charging of inductor 120. When switches 126 and 136 are closed, input voltage 110 is applied across boost inductor 120, storing energy in the inductor as it would during normal operations. Also, when boost switch 126 is closed, boost diode 124 is reverse-biased, preventing inrush current 130 from charging capacitors 138 and 122.

When switches 126, 136 are open, the charged inductor 120 delivers power to capacitors 138 and 122 through current limiting resistor 134. Capacitor 138 is charged to 373 volts and capacitor 122 is current limited by resistor 134. When both switches 126 and 136 close again, energy stored in capacitor 138 is then transferred into capacitor 122, and inductor 120 is charged for the next cycle. Inrush current 130 is, therefore, controlled pulse-by-pulse. This procedure continues until capacitor 122 reaches 373 volts or higher and then switch 136 is turned-on continuously thereby removing current limiting resistor 134 from boost converter circuit 116.

As noted, PFC control circuit 128 and inrush current control circuit 140 may generate two possible initial conditions at AC drop-in 302B. One condition is that both switches 126 and 136 are closed, as described above. The other condition is that switches 126 and 136 are open. When switches 126 and 136 remain open immediately subsequent to AC drop-in event 302B, inrush current 130 quickly charges capacitor 138 to its peak value of approximately 373 volts. The current flowing through capacitor 122 is limited by resistor 134 and is determined by the ratio of the voltage difference between input voltage 110 and the voltage already present across capacitor 122, that is, output voltage 118, divided by the resistance value of current limiting resistor 134. This is similar to the operations described above with reference to FIGS. 2A-2F. Thereafter, the operation of power supply circuit 100 is the same as that described above with reference to FIGS. 3A-3F.

Thus, when the AC line voltage 102 drops-out, inrush current control circuit 140 discharges soft-start capacitor 142 and prevents it from storing energy until AC line voltage 102 drops-in. With the return of AC line voltage 102, soft-start capacitor 148 begins to store energy, resulting in the gradual increase in soft-start voltage 142. This causes a corresponding gradual increase in the duty cycle of the pulse width modulated PFC control signal 144 and IC control signal 146, resulting in boost converter 116 slowly transitioning to steady-state condition. Although this results in output voltage 118 also changing slowly, inrush current 130 is limited during such AC line interruptions.

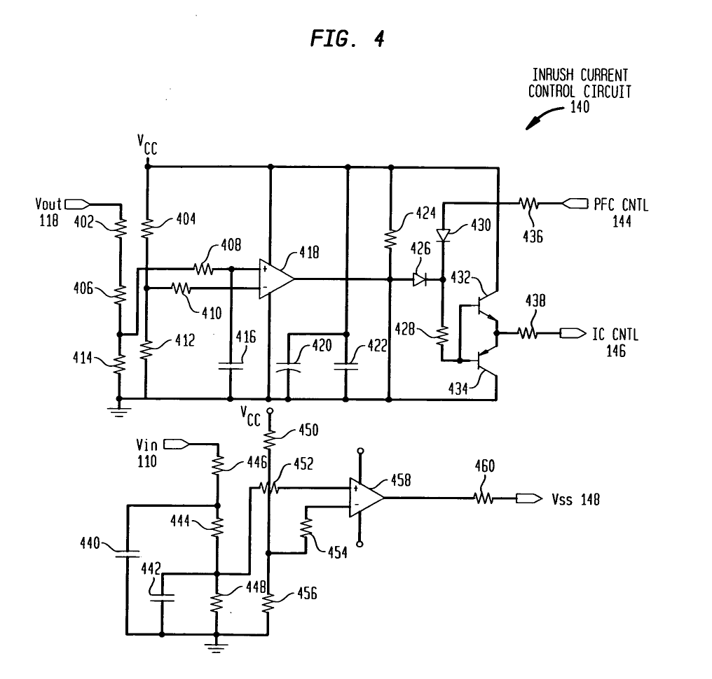

FIG. 4 is a simplified schematic diagram of inrush current control circuit 140 in accordance with one embodiment of the present invention. As noted, inrush current control circuit 140 receives as inputs output voltage 118, input voltage 110 and PFC control signal 144. Based on these inputs, inrush current control circuit 140 controls the voltage 148 of soft-start capacitor 142, and generates IC control signal 146 to control the gate of current limiting switch 136.

As will be described in greater detail below, inrush current control circuit 140 generates IC control signal 146 based on PFC control circuit 144 generated by boost converter control circuit 128, and output voltage 118. In addition, inrush current control circuit 140 controls the charging of soft-start capacitor 142 utilized by boost converter control circuit 128 during AC drop-out period 304 based on input voltage 110.

Specifically, IC control signal 146 is determined based on output voltage 118 and PFC control signal 144. Output voltage 118 is provided to one input terminal of a comparator 418 through a voltage divider formed by resistors 402, 406 and 414. Due to the high voltage levels that output voltage 118 can achieve, there are two resistors 404 and 406 provided on the input leg of the voltage divider.

The other input terminal of comparator 418 is connected to rail voltage V_{CC} through a voltage divider circuit formed by resistors 404 and 412. In this embodiment, rail voltage V_{CC} is used as an indicator of whether output voltage 118 has reached steady state. When output voltage 118 has reached steady state, the output signal of comparator is held at a logic high level, otherwise it is held at a logic low level.

As shown in FIG. 4, transistors 432 and 434 are series connected PNP and NPN transistors with the output IC control signal 146 derived from a node between the two transistors. The base of both transistors 432, 434 is driven by either the output of comparator 418 or PFC control signal 144. As such, when the output of comparator 418 is a logic low signal, IC control signal 146 follows PFC control signal 144. On the other hand, when the output of comparator 418 is a logic high signal, IC control signal 146 is continuously held at a high logic level.

The operation of this embodiment of inrush control circuit 140 is illustrated in FIGS. 2C, 2E and 2F as well as FIGS. 3C, 3D and 3E. As shown therein, when output voltage 118 has attained its steady state value, IC control signal 146 is held high while PFC control signal 144 is pulsed, whereas when there is an interruption in the AC line voltage 102 and during inrush current conditions, output voltage 118 is below its steady state value and IC control signal 146 follows PFC control signal 144.

As shown in FIG. 4, inrush control circuit 140 also comprises a comparator circuit that drives soft-start voltage 148 based on input voltage 110. When input voltage 110 is below a reference voltage formed by dividing the Vcc with resistors 450 and 456, such as, for example, when AC line interruption 304 occurs, the output of comparator 458 is low; otherwise, the comparator output is high. The operation of this embodiment of inrush control circuit is illustrated in FIGS. 3A and 3B. As described above, when AC line voltage 102 is interrupted, input voltage 110 (not shown) also decreases to zero volts. As shown in FIG. 3B, when this occurs, inrush current control circuit 140 drives soft-start voltage 148 to a low reference voltage (here, ground), and maintains this soft-start voltage level until AC line voltage 102 drops-in.

As with boost converter control circuit 128, inrush current control circuit 140 derives its power from output voltage 118. As a result, when power supply circuit 100 initially receives line voltage 102, output voltage 118, as noted, is zero. Accordingly, boost converter control circuit 128 and inrush current control circuit 140 are not powered and their respective control signals 144 and 146 are maintained at a logic low value. In contrast, when power supply circuit 100 receives line voltage 102 after a momentary interruption 304, output voltage 118, as noted, is not zero. For example, in the illustration above, output voltage 118 was at approximately 300 volts at AC-drop-in 302B. Accordingly, boost converter control circuit 128 and inrush current control circuit 140 are continually powered and their respective control signals 144 and 146 are controlled as described above.

As one of ordinary skill in the art would appreciate, the circuit arrangement shown in FIG. 4 is just one of a myriad of circuit arrangements which can be utilized to implement the above functionality. For example, in the above exemplary embodiment, inrush current control signal 146 and soft-start voltage 148 are functionally separate. As a result, inrush current control circuit 140 comprises two functionally-distinct circuits. In one embodiment, comparators 418 and 458 are implemented in a single circuit component. In such an embodiment, inrush current control circuit 140 is implemented as a single, integrated circuit. In another embodiment, comparators 418 and 458 and their associated components are implemented in separate circuit components. In such an embodiment, the portion of inrush current control circuit 140 that generates inrush current control signal 146 may be implemented in one circuit, while the portion of inrush current control circuit 140 that generates soft-start voltage 148 may be implemented in another circuit.

In light of the above detailed description of various embodiments, it should be appreciated that during inrush current conditions when AC line voltage 102 is initially applied to power supply circuit 100, inrush current control circuit 132 maintains resistor 134 in series with output capacitor 122, and maintains capacitor 138 in parallel with output capacitor 122. This results in the rapid attenuation of inrush current 130 while output voltage 118 gradually increases.

During inrush current conditions when AC line voltage 102 drops-in after a momentary interruption, inrush current control circuit 140 causes boost switch 126 and current limiting switch 136 to be synchronously switched at gradually increasing duty cycles, causing energy to be initially stored in current limiting capacitor 138 and incrementally transferred to and stored in output capacitor 122. During such transfer of energy from one capacitor to the other, inrush current 130 is limited by resistor 134. When the inrush current condition ceases, current limiting switch 136 remains closed, thereby allowing boost converter 116 to operate normally without the operational presence of resistor 134. By simultaneously switching switches 126,136, inrush current 130 is limited by resistor 134 when the switches are open. When the switches are closed, inrush current 130 is limited by the short and gradually-increasing duration the switches are closed in combination with inductor 120. Thus, inrush current 130 is limited pulse-by-pulse of control signals 144, 146 during AC drop-in condition 302B.

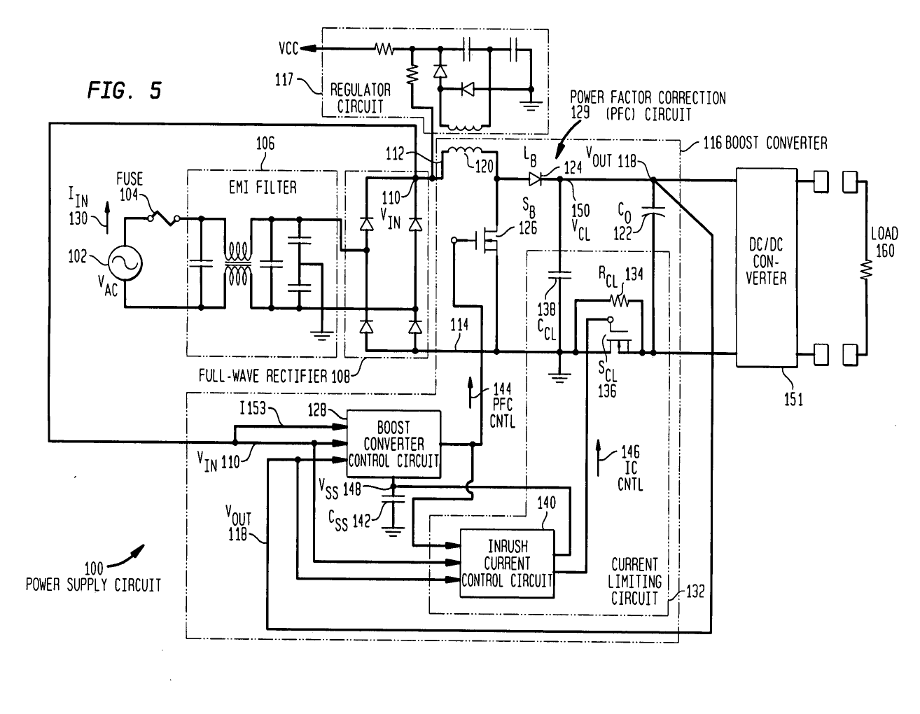

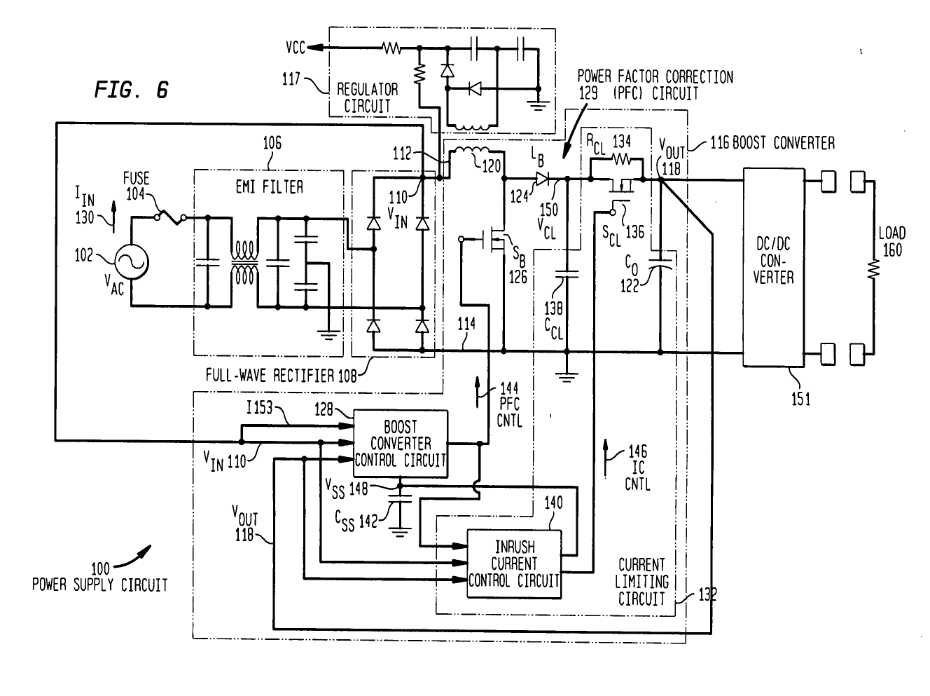

FIGS. 5 and 6 are schematic diagrams of alternative embodiments of power supply circuit 100 in which the parallel arrangement of current limiting switch 136 and current limiting resistor 134 is located at different locations along the circuit path containing output capacitor 122 which is parallel to the circuit path containing current limiting capacitor 138. In FIG. 5, the parallel arrangement of current limiting switch 136 and current limiting resistor 134 is located closer to the ground connection on conductor 114, while in FIG. 6, the parallel arrangement of current limiting switch 136 and current limiting resistor 134 is located between output capacitor 122 and diode 124.

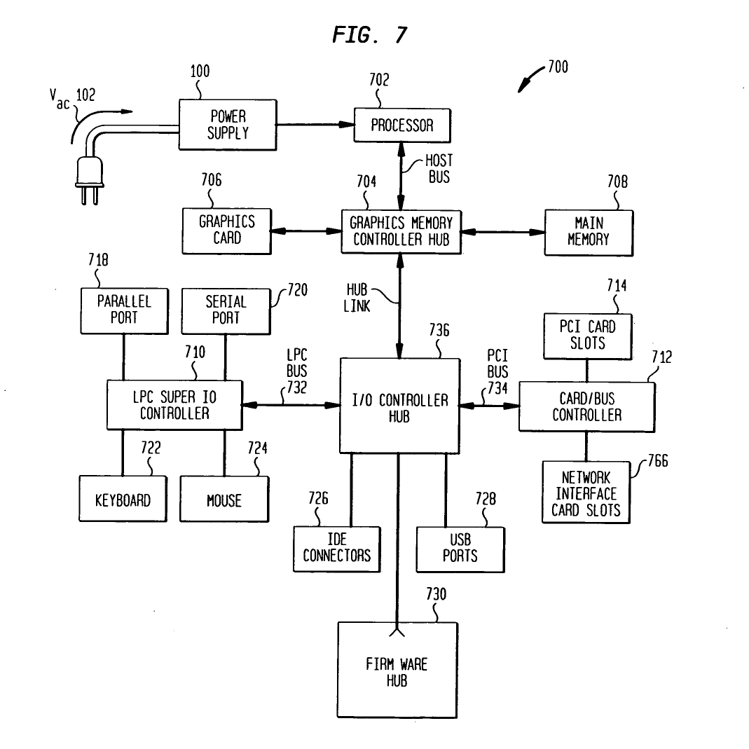

FIG. 7 is a block diagram of an exemplary device in which embodiments of the present invention may be implemented. The exemplary device depicted in FIG. 7 is a computer system such as a desktop computer, server, workstation, portable computer, and the like. It should be appreciated by those of ordinary skill in the art, however, that some embodiments of the present invention can be implemented in, for example, in any power-consuming device now or later developed.

Exemplary computer system 700 comprises a processor 702 connected directly to a controller chipset that manages the flow of data in computer 700. The controller chipset comprises a memory controller hub 704, commonly referred to as a Northbridge, which is connected to processor 702 via a host bus. Memory controller hub 704 is connected to an input/output (I/O) controller hub 736, commonly referred to as a Southbridge, via a hub interface bus. In one embodiment, processor 102 may be a microprocessor such a Pentium IV or other suitable microprocessor. The controller chipset comprising memory controller hub 704 and I/O controller hub 736 may be, for example, an 875P chipset, commercially available from Intel, Inc.

Memory controller hub 704 manages the flow of information between various interfaces, commonly referred to as host bridge interfaces. Specifically, memory controller hub 704 manages the interface with processor 702 and main memory 708. Memory controller hub 704 also supports an external graphics device 706 via, for example, an AGP interface. Memory controller hub 104 arbitrates between these and, perhaps other, interfaces, providing data coherency and performing address translation as necessary.

I/O Controller Hub 736 provides the data buffering and interface arbitration required to ensure that a variety of system interfaces operate efficiently. I/O controller hub 736 integrates controllers such as a low pin count (LPC) super I/O controller 710 and card/bus controller 712. Low pin count (LPC) super I/O controller 710 to support peripheral devices such as keyboard 722, mouse 724 and other devices connected to serial and parallel ports 720, 718. Controller 710 communicates with I/O controller hub 736 via an LPC bus 732. Card/bus controller 712 controls communications with devices connected to computer 700 via PCI card slots 714 and network interface cards slots 766. Communications via Universal Serial Bus (USB) ports 728 and IDE connectors 726, and with a firmware hub 730 are also supported by I/O controller hub 736. The above and other components of computer system 700 are well-known to those of ordinary skill in the art and are not described further herein.

Computer system 700 further comprises a system board (not shown) that interconnects the above and other system components and peripheral devices. An embodiment of power supply circuit 100 of the present invention is included in computer 700 to provide DC output voltages to system components and certain peripheral devices.

The embodiments of the present invention described above are exemplary only. For example, inrush current is present when an AC input peak voltage is higher than the voltage 118. In the embodiment described below, the input AC line voltage 102 is sensed to determine when the inrush condition is occurring. It should be appreciated by those of ordinary skill in the art, however, that the control principles of the present invention can be implemented by directly or indirectly sensing or calculating the input AC voltage.

1. A power factor correction circuit comprising:
an inductor having an input terminal to receive an input voltage and an output terminal series connected to an anode of a diode;
a first capacitor connected between a cathode of said diode and ground;
a first switch connected between an anode of said diode and ground;
a series arrangement of a second capacitor and a resistor coupled between said diode cathode and ground; and
a second switch connected in parallel with said resistor.

2. The circuit of claim 1, further comprising:
a control circuit operable to generate synchronous first and second switch control signals to respectively control said first and second switches, wherein during inrush current conditions when said input voltage drops-in after an interruption, said control circuit is operable to cause said first and second switches to be synchronously switched at increasing duty cycles.

3. The circuit of claim 2, wherein said control circuit comprises:
a first control circuit operable to generate a first switch control signal having a duty cycle based on a soft-start capacitor voltage;
a second control circuit operable to generate a second switch control signal having a same instantaneous value as said first switch control signal when said output voltage is below a steady state value, and having a first logic value when said output voltage is approximately at said steady state value; and
a third control circuit operable to discharge said soft-start capacitor when said input voltage to the power factor correction circuit is interrupted.

4. The circuit of claim 1, wherein said input voltage is a rectified voltage signal derived from an AC source voltage.

5. The circuit of claim 2, wherein, during inrush current conditions caused by initial receipt of said input voltage, said control circuit maintains said resistor in series with said second capacitor, and maintains said first capacitor in parallel with said second capacitor.

6. The circuit of claim 2, wherein synchronously switching said first and second switches at gradually increasing duty cycles causes energy to be initially stored in said first capacitor and incrementally transferred to and stored in said second capacitor, wherein during such transfer, said inrush current is limited by said resistor.

7. The circuit of claim 1, wherein said first and second capacitors have a relative capacitance that cause said first capacitor to charge more quickly than said second capacitor.

8. A power supply circuit for receiving an AC input voltage and for generating a DC output voltage, comprising:
an inductor having an input terminal to receive an input voltage and an output terminal series connected to an anode of a diode;
a first capacitor connected between a cathode of said diode and ground;
a first switch connected between an anode of said diode and ground;
a second capacitor connected between said diode cathode and ground to provide an output voltage; and
a parallel arrangement of a resistor and a second switch series connected with said second capacitor.

9. The power supply circuit of claim 8, further comprising:
a phase control rectifying circuit operable to receive said AC input voltage and to generate a rectified input voltage signal.

10. The power supply circuit of claim 8, further comprising:
a regulator circuit coupled to said inductor to receive said rectified input voltage signal and to generate a DC voltage signal.

11. The power supply circuit of claim 9, wherein said input voltage is generated by a phase control rectifying circuit comprising:
an electromagnetic interference (EMI) filter that filters an AC source voltage; and
a full-wave rectifier that rectifies said AC source voltage to provide said input voltage.

12. The power supply circuit of claim 8, further comprising:
a control circuit operable to generate synchronous first and second switch control signals to respectively control said first and second switches, wherein during inrush current conditions when said input voltage drops-in after an interruption, said control circuit is operable to cause said first and second switches to be synchronously switched at increasing duty cycles.

13. The power supply circuit of claim 12, wherein said control circuit comprises:
a first control circuit operable to generate a first switch control signal having a duty cycle based on a soft-start capacitor voltage; and
a second control circuit operable to generate a second switch control signal having a same instantaneous value as said first switch control signal when said output voltage is below a steady state value, and having a first logic value when said output voltage is approximately at said steady state value.

14. The power supply circuit of claim 13, wherein said control circuit further comprises:
a third control circuit operable to discharge said soft-start capacitor when said input voltage to the power factor correction circuit is interrupted.

15. The power supply circuit of claim 12, wherein, during inrush current conditions caused by initial receipt of said input voltage, said control circuit maintains said resistor in series with said second capacitor, and maintains said first capacitor in parallel with said second capacitor.

16. The power supply circuit of claim 12, wherein synchronously switching said first and second switches at gradually increasing duty cycles causes energy to be initially stored in said first capacitor and incrementally transferred to and stored in said second capacitor, wherein during such transfer, said inrush current is limited by said resistor.

17. The power supply circuit of claim 8, wherein said first and second capacitors have a relative capacitance that cause said first capacitor to charge more quickly than said second capacitor.

18. A system comprising:
a power supply circuit for receiving an AC input voltage and for generating a DC output voltage, comprising:
an inductor having an input terminal to receive an input voltage and an output terminal series connected to an anode of a diode;
a first capacitor connected between a cathode of said diode and ground;
a first switch connected between an anode of said diode and ground;
a second capacitor connected between said diode cathode and ground to provide an output voltage; and
a parallel arrangement of a resistor and a second switch series connected with said second capacitor.

19. The system of claim 18, wherein the system is a computer system.

20. The system of claim 18, further comprising:
a phase control rectifying circuit operable to receive said AC input voltage and to generate a rectified input voltage signal.

21. The system of claim 18, further comprising:
a regulator circuit coupled to said inductor to receive said rectified input voltage signal and to generate a DC voltage signal.

22. The power supply circuit of claim 18, wherein said input voltage is generated by a phase control rectifying circuit comprising:
an electromagnetic interference (EMI) filter that filters an AC input voltage; and
a full-wave rectifier that rectifies said AC source voltage to provide said input voltage.

23. The power supply circuit of claim 18, further comprising:
a control circuit operable to generate synchronous first and second switch control signals to respectively control said first and second switches, wherein during inrush current conditions when said input voltage drops-in after an interruption, said control circuit is operable to cause said first and second switches to be synchronously switched at increasing duty cycles.

24. The power supply circuit of claim 23, wherein said control circuit comprises:
a first control circuit operable to generate a first switch control signal having a duty cycle based on a soft-start capacitor voltage;
a second control circuit operable to generate a second switch control signal having a same instantaneous value as said first switch control signal when said output voltage is below a steady state value, and having a first logic value when said output voltage is approximately at said steady state value; and
a third control circuit operable to discharge said soft-start capacitor when said input voltage to the power factor correction circuit is interrupted.

25. A method for controlling inrush current in a power supply, comprising:
charging a first capacitor from an input voltage source;
isolating the first capacitor from the input voltage source;
transferring a portion of charge stored in said first capacitor to a second capacitor while said input voltage source is isolated from said first capacitor and from said second capacitor; and
repeatedly said charging, isolating, and transferring until a voltage is formed on said second capacitor that is approximately equal to said input voltage source.
